(19) United States
(12) Patent Application Publication
(10) Pub. No.: US 2008/0149747 A1
(43) Pub. Date: Jun. 26, 2008

(54) Shredder paper passage with a narrower neck part

(75) Inventor: Simon Huang, SanChung City (TW)

Correspondence Address: BACON & THOMAS, PLLC, 625 SLATERS LANE, FOURTH FLOOR, ALEXANDRIA, VA, 22314, US

(73) Assignee: Michilin Prosperity Co., Ltd., SanChung City (TW)

(21) Appl. No.: 11/878,486

(22) Filed: Jul. 25, 2007

(30) Foreign Application Priority Data
Dec. 26, 2006 (CN) 200620139375.7

(51) Int. Cl. B02C 23/00

(52) U.S. Cl. 241/96

(57) ABSTRACT

This specification discloses a shredder paper passage with a narrower neck part. From top down, the shredder paper passage has a first passage and a second passage, both in a horn shape. The intersection of the two passages forms the narrowed neck part. When the user's fingers are inserted into the paper passage, they are stopped by the narrower neck part. This protects the user from getting hurt.

### BACKGROUND OF THE INVENTION

1. Field of Invention

The invention relates to a shredder and, in particular, to a shredder paper passage with a narrower neck part to prevent the user from inserting fingers and getting hurt.

2. Related Art

To prevent such documents as legal files, receipts, invoices, credit card numbers, research reports, or personal financial information (e.g., credit card and phone bills) from being released, it is common to destroy them using a shredder. Therefore, the shredder has become an indispensable device for both business and home applications.

The US Consumer Product Safety Commission (CPSC) issued document No. 5127 in response to paper shredder safety alert. The document reminded families with shredders to be cautious about the safety in operating the shredders. It pointed out that 31 cases of finger injuries from operating shredders have been the received reports between January 2000 and December 2003, and most of the people who got hurt were children aged from 14 months to 2 years, particularly the toddlers. This is because children at these ages like to mimic adults and play shredder without the adult's supervision. It is not guaranteed that no accident will happen even under the adult's supervision. This is because the pulling force exert by the shredder on the paper is very large. If the fingers holding the paper do not let go, the pulling force may also pull the fingers into the shredder opening and cause injuries.

Therefore, the CPSC cautioned consumers about the following things:
1. Do not let children to operate shredders by themselves. Even under supervision, the adult should know that there is a risk that the pulling force of the shredder may be strong enough to pull children's fingers into the shredder opening.
2. Keep shredders away from children.
3. Unplug the shredder when not in use.
4. Do not put hands or fingers on the shredder.
5. Do not operate shredders when wearing clothes with loose ends or strips to avoid being pulled into the shredder opening.
6. Keep an appropriate distance between the tie or zipper and the shredder opening.

The opening width of an ordinary shredder may be wide enough for a child to stick in fingers and get hurt by the blades. Therefore, it is imperative to provide a safety protection device at the opening to prevent injuries.

### SUMMARY OF THE INVENTION

In view of the foregoing, an objective of the invention is to provide a shredder paper passage with a narrower neck part. The shredder paper passage is designed to have a first passage and a second passage, both in a horn shape. The intersection of the two passages forms the narrower neck part. When the user's fingers are inserted into the paper passage, they are stopped by the narrower neck part. This protects the user from getting hurt.

Another objective of the invention is to provide a shredder paper passage with a narrower neck part, in which the heights of the first and second passages are ⅓ and ⅔ of the height of the entire passage, respectively. Since the second passage has a wider space, it is unlikely to have paper jam when the shredder is in the rev mode.

To achieve the above objectives, the disclosed shredder paper passage with a narrower neck part is divided from top to bottom into a first passage and a second passage, both in a horn shape. The intersection of the two passages forms the narrower neck part. When the user's fingers are inserted into the paper passage, they are stopped by the narrower neck part. This protects the user from getting hurt.

### BRIEF DESCRIPTION OF THE DRAWINGS

The invention will become more fully understood from the detailed description given herein below illustration only, and thus is not limitative of the present invention, and wherein:

FIG. 1 is a planar view showing the structure of the invention.

### DETAILED DESCRIPTION OF THE INVENTION

The present invention will be apparent from the following detailed description, which proceeds with reference to the accompanying drawings, wherein the same references relate to the same elements.

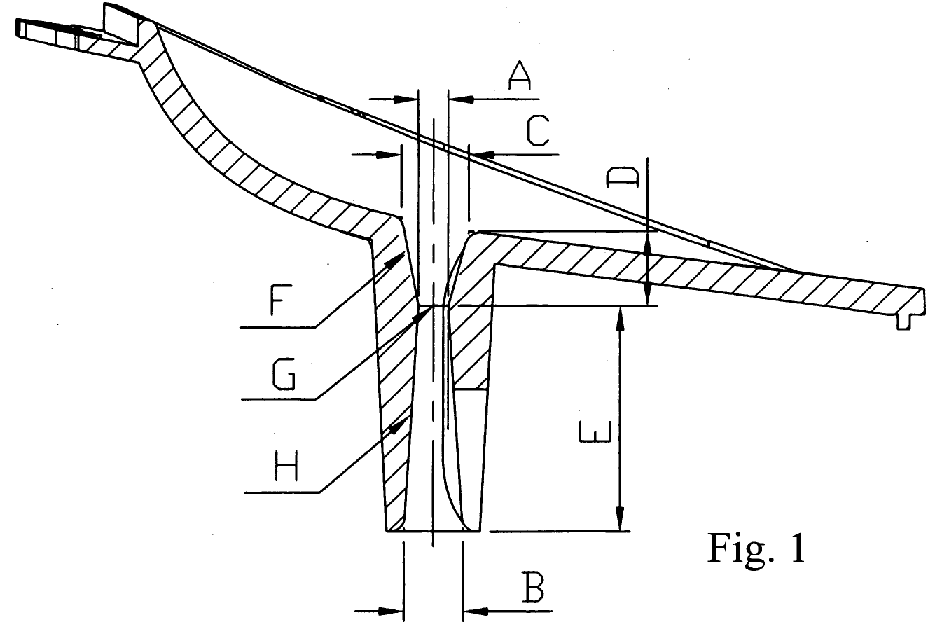

With reference to FIG. 1, the disclosed shredder paper passage is divided from top to bottom into a first passage F and a second passage H. The intersection of the two passages forms the neck part G.

The first passage F has the largest width at the opening of the passage. It gradually shrinks until the end of its passage. That is, the neck part G has the smallest width A. Therefore, the first passage F has a horn shape with a larger width on the top and a smaller width at the bottom. Its height D is ⅓ of the total height of the entire paper passage.

The second passage H has the smallest width A at the neck part A. It gradually gets larger, and has the largest width B at the passage outlet. The second passage H is also in a horn shape, but with a smaller width on the top and a larger width at the bottom. Its height E is ⅔ of the total height of the entire paper passage.

The neck part G is the intersection of the first passage F and the second passage H. Its width A is the narrowest part of the entire paper passage.

With the above-mentioned design, the user cannot stick his/her finger completely into the paper passage because the narrow neck part G. This protects the safety of the user. Moreover, the second passage has a wider space. Therefore, it is unlikely to have paper jams when the shredder is in the rev mode.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A shredder paper passage with a narrower neck part, comprising a first passage and a second passage from top to bottom with the intersection of the two passages forming the narrow neck part; wherein the narrow neck part stops user's fingers from completely inserting into the paper passage.

2. The shredder paper passage with a narrower neck part of claim 1, wherein the first passage has the largest width at the entrance of the paper passage, gradually shrinks to its bottom, and has the smallest width at the neck part, forming a horn shape with a wide top and a narrow bottom and a height of ⅓ of the entire paper passage.

3. The shredder paper passage with a narrower neck part of claim 1, wherein the second passage has the smallest width at the neck part, gradually enlarges to its bottom, and has the largest width at the paper outlet, forming a horn shape with a narrow top and a wide bottom and a height of ⅔ of the entire paper passage.
